(19) United States
(12) Patent Application Publication
(10) Pub. No.: US 2015/0322100 A1
(43) Pub. Date: Nov. 12, 2015

(54) POLYSUBSTITUTED ARENES AND SYNTHESIS THEREOF

(71) Applicant: JACOBS UNIVERSITY BREMEN GGMBH, BREMEN (DE)

(72) Inventors: GERD-VOLKER ROESCHENTHALER, BREMEN (DE); BLAZEJ DUDA, BERLIN (DE); SERGEY N. TVERDOMED, BREMEN (DE)

(73) Assignee: JACOBS UNIVERSITY BREMEN GGMBH, BREMEN (DE)

(21) Appl. No.: 14/399,162

(22) PCT Filed: Apr. 23, 2013
(86) PCT No.: PCT/DE2013/100150

§ 371 Date: Nov. 6, 2014

(30) Foreign Application Priority Data
May 7, 2012 (DE) 10 2012 104 007.9

(51) Int. Cl. C07F 9/40

(52) U.S. Cl. CPC C07F 9/4021

(57) ABSTRACT

A compound having general formula (I)

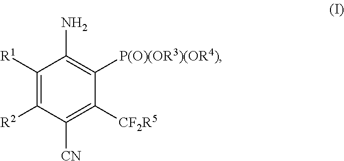

wherein, R¹ and R² are, independently of each other, CN or NH₂, or together form a substituted aromatic ring system or an unsubstituted aromatic ring system. R³ and R⁴ are, independently of each other, C₁-C₁₂-alkyl. R⁵ is H, a halogen, or CₙF₂ₙ₊₁, wherein n=1-10.

### CROSS REFERENCE TO PRIOR APPLICATIONS

This application is a U.S. National Phase application under 35 U.S.C. §371 of International Application No. PCT/DE2013/100150, filed on Apr. 23, 2013 and which claims benefit to German Patent Application No. 10 2012 104 007.9, filed on May 7, 2012. The International Application was published in German on Nov. 14, 2013 as WO 2013/167117 A1 under PCT Article 21(2).

### FIELD

The present invention relates to polysubstituted arenes, more specifically, to polysubstituted benzenes and naphtalenes as well as to a method for their synthesis.

Fully substituted benzenes and naphtalenes are of great interest since they have significant bioactivity, for example, anti-inflammatory and anti-hyperglycemic properties (Ram, V. J.; Agarwal, N. Tetrahedron Lett. 2001, 42, pp. 7127-29). Such compounds have also often been used to synthesize bioactive heterocyclic compounds (Wang, X.-S.; Zhang, M.-M.; Li, Q.; Yao, C.-S.; Tu, S.-J. Tetrahedron Lett. 2007, 63, pp. 5265-73). Among these compounds, the so-called acceptor-donor-acceptor (A-D-A) systems (Xue, D.; Li, J.; Zhang, Z.-T.; Deng, J.-G., J. Org. Chem. 2007, 72, pp. 5443-45), e.g., 2,4-dicyanoaniline, on the aryl ring have shown great potential for synthetic photosynthesis systems (Heilman, W. P.; Battershell, R. D.; Pyne, W. J.; Goble, P. H.; Magee, T. A.; Matthews, R. J., J. Med. Chem. 1978, 21, pp. 906-13) and also non-linear optical properties (Singh, F. V.; Parihar, A.; Chaurasia, S.; Singh, A. B.; Singh, S. P.; Tamrakar, A. K.; Srivastava, A. K.; Goel, A., Bioorg. Med. Chem. Lett. 2009, 19, pp. 2158-61).

As opposed to naturally-occurring phosphate analogs, the phosphonate group does not easily hydrolyze in a biological environment and is therefore more useful for a plurality of applications (Yakaiah, T.; Lingaiah, B. P. V.; Narsaiah, B.; Shireesha, B.; Ashok Kumar, B.; Gururaj, S.; Parthasarathy, T.; Sridhar, B., Bioorg. Med. Chem. Lett. 2007, 17, pp. 3445-53). In contrast, fluorinated groups improve chemical and physical stability and also pass the blood-brain barrier more easily than comparable non fluorinated compounds (Dumur, F.; Gautier, N.; Gallego-Planas, N.; Sahin, Y.; Levillain, E.; Mercier, N.; Hudhomme, P.; Masino, M.; Girlando, A.; Lloveras, V.; Vidal-Gancedo, J.; Veciana, J.; Rovira, C., J. Org. Chem. 2004, 69, pp. 2164-77). It must be pointed out in this context that 20-25% of the drugs in the drug pipeline have at least one fluorine atom.

Polysubstituted benzenes and naphthalenes were until now mainly produced by a sequential introduction of specific substituents, e.g., electrophilic (Xiao, Y.; Qian, X., Tetrahedron Lett. 2003, 44, pp. 2087-91), nucleophilic aromatic substitution (Kuneck, H.; Huber, M., Angew. Chem. Int. Ed. 1995, 34, pp. 849-66) at the center of the arene, and by coupling reactions (Long, N. J., Angew. Chem. Int. Ed. 1995, 34, pp. 21-38). A transition metal catalyzed cyclization of the corresponding unsaturated substrates for producing aromatic compounds has also previously been described (Engel, R., Chem. Rev. 1977, 77, pp. 349-67). A reaction of 2-aminoprop-1-ene-1,3,3-tricarbonitrile (IIb) with nitro-alkene derivatives 1 has recently been successfully used to produce polysubstituted benzene 2 under microwave irradiation (O'Hagan, D., Chem. Soc. Rev. 2008, 37, pp. 308-19).

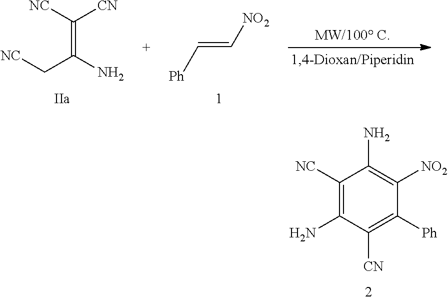 [SMILES: N#CCC(N)=C(C#N)C#N ; O=[N+]([O-])/C=C/c1ccccc1 ; N#Cc1c(N)c(C#N)c(-c2ccccc2)c([N+](=O)[O-])c1N]

Singh et al. additionally described that 2H-pyrane-2-one 3 can be transformed into arylated benzene derivatives 4 by way of a nucleophilic induced ring transformation reaction with malonitrile in the presence of a strong base.

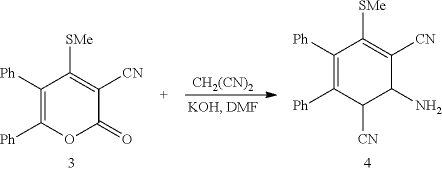

A good yield of naphthalene derivatives (Purser, S.; Moore, P. R.; Swallow, S.; Gouverneur, Y., Chem. Soc. Rev. 2008, 37, pp. 320-30) 6 was successfully obtained by reacting 2-(cyanomethyl)benzonitrile IIb with 3-Bromo-2-(ethylthio)but-2-enenitriles 5 (Pearson, D. E.; Buehler, C. A., Synthesis 1972, 1972, 533, pp. 42).

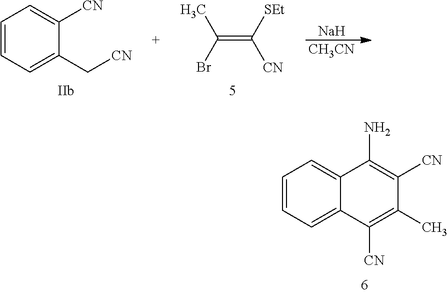

The difficulty of introducing functional groups, for example, amine, cyano or ester groups into an aromatic ring has previously been described (Buncel, E.; Dust, J. M.; Terrier, F., Chem. Rev. 1995, 95, pp. 2261-80). There is, however, a need for polysubstituted arenes, for example, for use as pharmacophores (Saito, S.; Yamamoto, Y., Chem. Rev. 2000, 100, pp. 2901-16) and for a method for their production.

### SUMMARY

An aspect of the present invention is to provide such polysubstituted arenes. Another aspect of the present invention is to provide a relatively simple, atom-efficient, and regioselective method for producing the polysubstituted arenes.

In an embodiment, the present invention provides a compound having general formula (I)

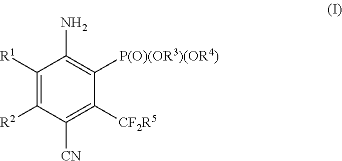

wherein, R¹ and R² are, independently of each other, CN or NH₂, or together form a substituted aromatic ring system or an unsubstituted aromatic ring system. R³ and R⁴ are, independently of each other, C₁-C₁₂-alkyl. R⁵ is H, a halogen, or CₙF₂₊₁, wherein n=1-10

### DETAILED DESCRIPTION

The present invention provides a compound with the general formula (I),

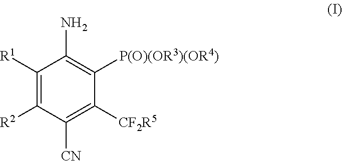

wherein

R¹ and R² are, independently of each other, CN or NH₂, or together form a substituted or unsubstituted aromatic ring system,

R³ and R⁴ are, independently of each other, a C₁-C₁₂-alkyl, and

R⁵ is H, halogen or CₙF₂ₙ₊₁, with n=1-10.

For the first time, the present invention thus provides polysubstituted arenes that are substituted with a group containing fluorine and a phosphonate group. The compound with the formula (I) according to the present invention contains, in addition to a cyano group and an amino group, a (hydrophilic) phosphonate group in the vicinity of a (lipophilic) group containing fluorine.

The term “substituted” means that one or several substituents are present which replace a hydrogen atom on one or several carbon atoms of a hydrocarbon structure, for example, on one or several of the ring carbon atoms of a cyclic aromatic hydrocarbon compound. Examples of such substituents are alkyl, oalkyl, cycloalkyl, aryl, heteroaryl, halogen, hydroxyl, phosphate, cyano and amino groups.

“Polysubstituted” means multi-substituted and here more specifically means that several, for example, all H atoms on the C atoms of the benzene ring in formula (I) are substituted by substituents. The substituents can be e.g., cyano groups, amino groups and the like. “Polysubstituted benzene” can mean, for example, that respectively one cyano group is bonded in place of H atoms with two C atoms of a benzene ring, respectively, one amino group is bonded with two other C atoms, a phosphonate group is bonded with one C atom, and a group containing fluorine is bonded with the remaining C atom. “Polysubstituted naphthalene” can mean that the four not common C atoms on one of the benzene rings are substituted with e.g., a cyano, an amino, a phosphonate group and a group containing fluorine.

“Polyfunctionally substituted” means polysubstituted with as many different functional groups as possible, at least, however, with two such functional groups, as substituents, e.g., substitution of the benzene ring with an amino, a cyano, a phosphonate group and a group containing fluorine. If not explicitly stated otherwise, the terms “polysubstituted” and “polyfunctionally substituted” are used here as synonyms.

“Completely substituted” means that the benzene ring of a compound with the formula I according to the present invention has a substitution at each of its ring C atoms, i.e., none of the ring C atoms carries H atoms.

The term “halogen” refers to elements of the group 17 of the periodic table of elements, e.g., fluorine, chlorine, bromine and iodine.

The feature according to which R¹ and R² together form an aromatic substituted or unsubstituted ring system means that the rests R¹ and R² are bonded covalently with each other so that, when including those C atoms of the benzene ring of the compound with the formula (I) with which the rests R¹ and R¹ are bonded, for example, an anellated, aromatic ring system is formed. The ring system can be a one-membered, two-membered or multi-membered ring system, i.e., it can consist of one, two, or several rings, wherein the rings can be five-membered or six-membered rings, i.e., rings consisting of five or six ring atoms. The rings can, for example, be six-membered, i.e., consist of six ring atoms. The ring atoms can, for example, be C atoms, but can also be heteroatoms, e.g., nitrogen, oxygen, phosphate or sulfur atoms. The ring system does not, for example, contain heteroatoms. Polycyclic aromatic ring systems can thereby be formed, which, when including the benzene ring of the compound with the formula (I), have a naphthalene, anthracene, phenantrene, tetracene, phenalene or fluorene structure.

The term “arenes” refers to cyclic, planar hydrocarbons with an aromatic system.

The term “alkyl” contains saturated and unsaturated aliphatic (non-aromatic) groups, including straight-chain alkyl groups (e.g., methyl, ethyl, propyl, butyl, pentyl, hexyl, heptyl and octyl) and branched alkyl groups (e.g., isopropyl, tert-Butyl, isobutyl).

R⁵ is H, halogen or CₙF₂ₙ₊₁, wherein n=1-10, i.e., 1, 2, 3, 4, 5, 6, 7, 8, 9 or 10. R⁵ can, for example, be CF₃ (n=1), C₂F₅ (n=2), C₃F₇ (n=3) or C₄F₉ (n=4). R⁵ can, for example, be H, halogen or CF₃.

In an embodiment of the present invention, R¹ and R² form, together with those C atoms of the benzene ring of the compound with the formula (I) with which the rests R¹ and R² are bonded, a six-membered substituted or unsubstituted aromatic ring, for example, a benzene ring. The present invention thus provides, for example, polysubstituted naphthalene and/or naphthalene derivatives. The rests R¹ and R² can, however, also be bonded with other aromatic ring systems.

In an embodiment of the present invention, the compound has the general formula (Ia)

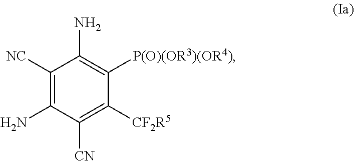

or the general formula (Ib)

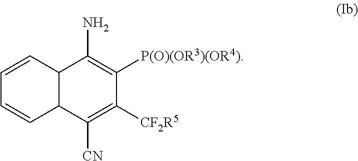

R³ and R⁴ are C₁-C₁₂-alkyl groups, i.e., alkyl groups with 1, 2, 3, 4, 5, 6, 7, 8, 9, 10, 11 or 12 C-atoms. Examples thereof are methyl, ethyl, propyl, butyl, pentyl, hexyl, heptyl, octyl, isopropyl, tert-Butyl, isobutyl and isopentyl groups. R³ and R⁴ can, for example, both be methyl or ethyl (Et).

In a second aspect, the present invention also relates to a compound according to the first aspect of the present invention for use as a drug. Compounds according to the general formula (I) have a promising potential as drugs, e.g., as anti-inflammatory and anti-hyperglycemic drugs.

In a third aspect, the present invention provides a method for producing a compound with the general formula (I),

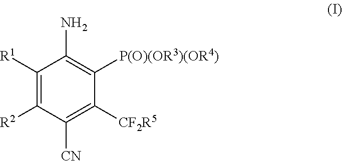

wherein

R¹ and R² are, independently of each other, CN or NH₂ or together form a substituted or unsubstituted aromatic ring system,

R³ and R⁴ are, independently of each other, C₁-C₁₂-alkyl, and

R⁵ is H, halogen or CₙF₂ₙ₊₁, with n=1-10, wherein a compound with the general formula (II)

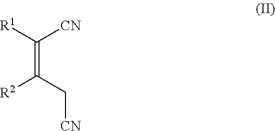

is reacted with a compound with the general formula (III)

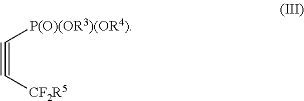

The method according to the present invention is relatively atom-efficient, easily implementable, and regioselective, and for the first time allows synthesizing polysubstituted arenes with a phosphonate group and a (vicinal) group containing fluorine as substituents.

In an embodiment of the method according to the present invention, a compound with the formula (II) is used, wherein R¹ and R², including those C atoms to which R¹ and R² are bonded, form a six-membered substituted or unsubstituted aromatic ring, for example, a benzene ring. The method can also be advantageously implemented, however, with compounds with the formula (II), wherein R¹ and R² form more complex aromatic ring systems, as described above, with regard to the first aspect of the present invention.

The method according to the present invention can, for example, lead to the formation of a compound with the general formula (Ia)

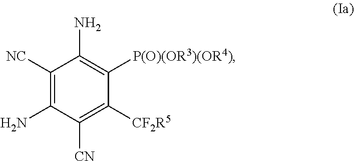

wherein a compound with the general formula (IIa)

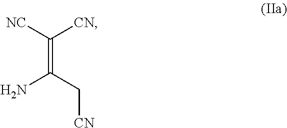

is reacted with a compound with the general formula (III)

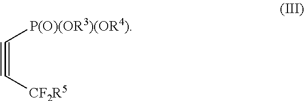

The method according to the present invention can, for example, also lead to the production of a compound with the general formula (Ib)

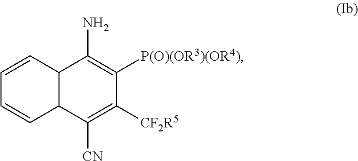

wherein a compound with the general formula (IIb)

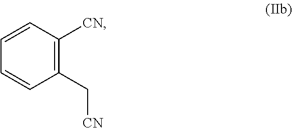

is reacted with a compound with the general formula (III)

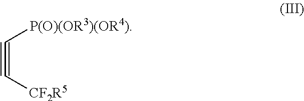

In an embodiment of the method according to the present invention, an aprotic nonpolar solvent, e.g., benzole or toluol, is added at room temperature to a mixture of a compound with the general formula (II), (IIa) or (IIb) and a base, which can be K₂CO₃ or a tertiary amine such as, for example, iPr₂NEt, NEt₃ (Et=ethyl, Pr=propyl) or DABCO (1,4-Diazabicyclo[2.2.2]octane), and the resulting mixture is refluxed, i.e., cooked under reflux. The solvent used can, for example, be anhydrous, e.g., anhydrous toluol.

The present invention is described in more detail below based on exemplary embodiments for illustrative purposes only.

### EXAMPLES

Exemplary compounds according to the present invention were produced according to the following schema:

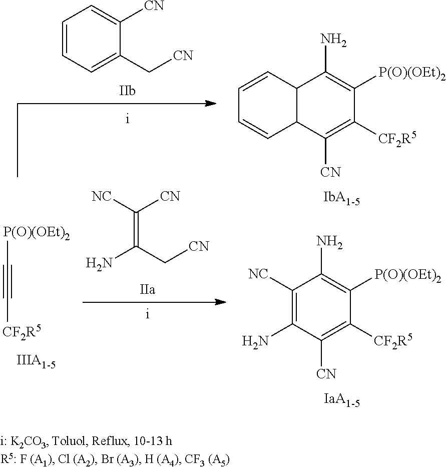

Anhydrous toluol (20 ml) was added at room temperature to a mixture of IIa or IIb and K₂CO₃ (5 mmol). The acetylenic compounds IIA₁₋₅ (IIIA₁: R⁵═F; IIIA₂: R⁵═Cl; IIIA₃: R⁵═Br; IIIA₄: R⁵═H; IIIA₅: R⁵═CF₃) (5 mmol) were then slowly added. The solution was cooked for another 11-13 hours under reflux. The K₂CO₃ was filtered out and the remaining solution was concentrated at a reduced pressure. The residue was cleaned by flash column chromatography on silica gel using DCM:EtOAc (ratio 5:1; DCM=dichloromethane, EtOAc=ethyl acetate) as an eluent.

### Example 1

### Diethyl(2,4-diamino-3,5-dicyano-6-(trifluoromethyl)phenyl)phosphonate IaA₁

Colorless crystals (98%); Smp. 145-149° C.; ¹H NMR (CDCl₃, 400 MHz): δ 1.27 (t, J=6.9 Hz, 6H), 4.11 (m, 4H), 5.84 (s, 2H); ¹³C NMR (100 MHz): δ 16.0 (d, J=6.7 Hz), 63.3 (d, J=5.7 Hz), 83.1 (d, ³J_{C-P}=15.4 Hz), 85.0 (dq, ³J_{C-P}=14.4 Hz, ³J_{C-F}=2.9 Hz), 97.7 (d, ¹J_{C-P}=191.7 Hz), 114.2, 121.8 (qd, ¹J_{C-F}=278.9 Hz), ³J_{C-P}=6.7 Hz), 142.6 (qd, ²J_{C-F}=32.6 Hz, ²J_{C-P}=5.6 Hz), 155.1, 158.2 (d, ²J_{C-P}=10.5 Hz); ¹⁵NMR (41 MHz): δ 275.2 (—CN), 266.6 (—CN), 83.1 (—NH₂), 72.7 (—NH₂); ¹⁹F NMR (376 MHz): δ —55.3; ³¹P NMR (161 MHz): δ 16.3.

### Example 2

### Diethyl(2,4-diamino-6-(chlorodifluoromethyl)-3,5-dicyanophenyl)phosphonate IaA₂

Colorless crystals (94%); Smp. 150-153° C.; ¹H NMR (CDCl₃, 400 MHz): δ 1.33 (t, J=7.1 Hz, 6H), 4.13 (m, 4H), 5.71 (s, 2H); ¹³C NMR (100 MHz): δ 16.2 (d, J=6.7 Hz), 63.4 (d, J=6.7 Hz), 82.7 (d, ³J_{C-P}=15.3 Hz), 85.0 (dt, ³J_{C-P}=14.3 Hz, ³J_{C-F}=3.8 Hz), 96.6 (d, ¹J_{C-P}=192.6 Hz), 114.2, 114.4, 123.2 (td, ¹J_{C-F}=295.2 Hz), ³J_{C-P}=4.8 Hz), 148.6 (td, ²J_{C-F}=26.8 Hz, ²J_{C-P}=5.7 Hz), 154.9, 158.0 (d, ²J_{C-P}=10.5 Hz); ¹⁹F NMR (376 MHz): δ −43.5; ³¹P NMR (161 MHz): δ 16.8.

### Example 3

### Diethyl(1-amino-4-cyano-3-(trifluoromethyl)naphthalene-2-yl)phosphonate IbA₁

Yellowish crystals (97%); Smp. 162-165° C.; ¹H NMR (CDCl₃, 400 MHz): δ 1.33 (t, J=7.1 Hz, 6H), 4.11 (m, 2H), 4.19 (m, 2H), 7.63 (t, J=7.6 Hz, 1H), 7.74 (t, J=7.8 Hz, 1H), 7.97 (br. s, 2H), 7.97 (d, J=8.5 Hz, 1H), 8.25 (d, J=8.3 Hz, 1H); ¹³C NMR (100 MHz): δ 16.1 (d, J=7.3 Hz), 63.0 (d, J=6.0 Hz), 96.9 (dq, ¹J_{C-P}=186.6 Hz, ³J_{C-F}=1.2 Hz) 98.2 (dq, ³J_{C-P}=13.8 Hz, ³J_{C-F}=3.9 Hz), 116.9, 122.0 122.8 (qd, ¹J_{C-F}=278.3 Hz, ³J_{C-P}=5.3 Hz), 123.1 (d, ³J_{C-P}=14.3 Hz), 127.0, 128.9, 131.5, 133.4, 136.4 (qd, ²J_{C-F}=31.8 Hz, ²J_{C-P}=6.4 Hz), 155.7 (d, ²J_{C-P}=8.7 Hz); ¹⁹F NMR (376 MHz): δ −53.1; ³¹P NMR (161 MHz): δ 19.3.

### Example 4

### Diethyl(1-amino-3-(chlorodifluoromethyl)-4-cyanonaphthalene-2-yl)phosphonate IbA₂

Yellowish crystals (92%); Smp. 179-182° C.; ¹H NMR (CDCl₃, 400 MHz): δ 1.35 (t, J=7.1 Hz, 6H), 4.10 (m, 2H), 4.16 (m, 2H), 7.62 (t, J=8.3 Hz, 1H), 7.73 (t, J=8.1 Hz, 1H), 7.93 (d, J=8.5 Hz, 1H), 7.94 (br. s, 2H), 8.25 (d, J=8.4 Hz, 1H); ¹³C NMR (100 MHz): δ 16.3 (d, J=7.0 Hz), 63.1 (d, J=6.7 Hz), 96.9 (d, ¹J_{C-P}=188.3 Hz), 98.2 (dt, ³J_{C-P}=13.0 Hz, ³J_{C-F}=4.5 Hz), 116.2, 121.5 122.8 (d, ³J_{C-P}=13.2 Hz), 124.3 (td, ¹J_{C-F}=294.5 Hz, ³J_{C-P}=3.5 Hz), 126.9, 128.8, 131.5, 133.5, 142.8 (td, ²J_{C-F}=26.2 Hz, ²J_{C-P}=6.6 Hz), 155.4 (d, ²J_{C-P}=9.1 Hz); ¹⁹F NMR (376 MHz): δ −40.0; ³¹P NMR (161 MHz): δ 19.8 (t, ⁴J_{P-F}=1.6 Hz).

The present invention is not limited to embodiments described herein; reference should be had to the appended claims.

What is claimed is:

1-8. (canceled)

9. A compound having general formula (I) 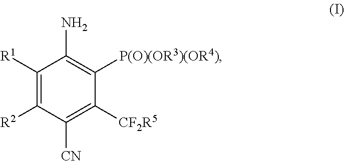
wherein,
R¹ and R² are, independently of each other, CN or NH₂, or together form a substituted aromatic ring system or an unsubstituted aromatic ring system;
R³ and R⁴ are, independently of each other, C₁-C₁₂-alkyl; and
R⁵ is H, a halogen, or CₙF₂ₙ₊₁, wherein n=1-10.

10. The compound as recited in claim 9, wherein R¹, R², and the C-atoms of the ring of the compound comprising general formula (I) to which R¹ and R² are bonded, form a six-membered substituted or unsubstituted aromatic ring.

11. The compound as recited in claim 11, wherein the six-membered substituted or unsubstituted aromatic ring is a benzene ring.

12. The compound as recited in claim 9, wherein the compound has general formula (Ia) 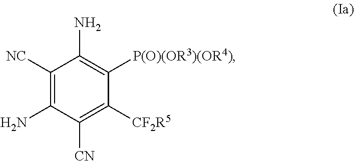
or general formula (Ib),

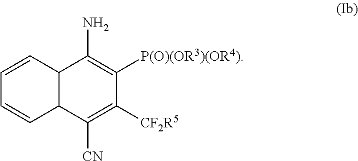

13. The compound as recited in claim 12, wherein R³ and R⁴ are ethyl rests.

14. A method of treating a disease comprising administering to a patient in need of the treatment an effective amount of the compound as recited in claim 9.

15. A method for producing a compound having general formula (I) 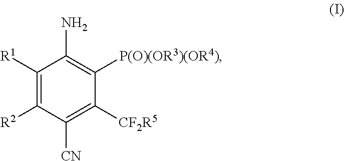
wherein,
R¹ and R² are, independently of each other, CN or NH₂, or together form a substituted aromatic ring system or an unsubstituted aromatic ring system;
R³ and R⁴ are, independently of each other, C₁-C₁₂-alkyl; and
R⁵ is H, a halogen, or CₙF₂ₙ₊₁, wherein n=1-10,
the method comprising:
reacting a compound having general formula (II) 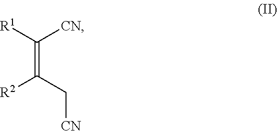
with a compound having general formula (III)

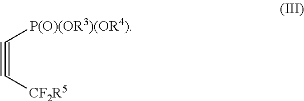

16. The method as recited in claim 15 using the compound having general formula (II), wherein R¹ and R², including the C-atoms to which R¹ and R² are bonded, form a six-membered substituted or unsubstituted aromatic ring.

17. The method as recited in claim 16, wherein the six-membered substituted or unsubstituted aromatic ring is a benzene ring.

18. A method for producing a compound having general formula (Ia) 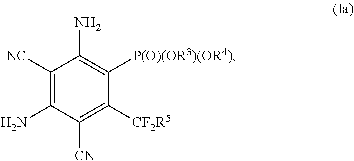
or having general formula (Ib) 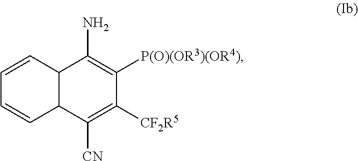
the method comprising:
reacting a compound having general formula (IIa) 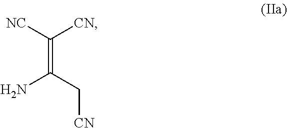
or a compound having general formula (IIb) 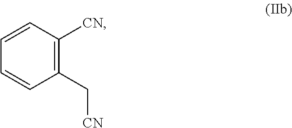
with a compound having general formula (III)

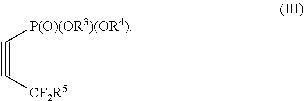

19. The method as recited in claim 18, the method comprising:
providing a mixture of a base and a compound having general formula (II), general formula (IIa), or general formula (IIb);
adding an aprotic nonpolar solvent at room temperature to the mixture;
adding a compound having general formula (III) to the mixture so as to obtain a second mixture; and
refluxing the second mixture.

20. The method as recited in claim 19, wherein the aprotic nonpolar solvent is toluol, and the base is K₂CO₃ or a tertiary amine.
